(19) United States
(12) Patent Application Publication
(10) Pub. No.: US 2026/0300469 A1
(43) Pub. Date: Oct. 1, 2026

(54) AUTOMATED TEST PROGRAM GENERATION FOR VALIDATING STATIC ANALYSIS TOOLS

(71) Applicant: MICROSOFT TECHNOLOGY LICENSING, LLC, Redmond, WA (US)

(72) Inventors: Alan Thomas Gavin JOWETT, Rathdrum, ID (US); Daniel Michael AGUN, JR., Bothell, WA (US)

(21) Appl. No.: 19/089,412

(22) Filed: Mar. 25, 2025

(51) Int. Cl. G06F 21/52

(52) U.S. Cl. CPC G06F 21/52; G06F 2221/033

(57) ABSTRACT

The techniques presented herein provide a system for validating a static analysis tool by utilizing automated generation of rigorous test programs that evaluate various aspects of the static analysis tool. In various examples, the test program comprises a sequence of instructions that perform operations and can be safe or unsafe operations. Accordingly, the static analysis tool analyzes the instructions to identify the operations and classifies the test program as either a safe program or an unsafe program. If the static analysis tool classifies the test program as safe, the test program is then executed by a concrete implementation (e.g., virtual machine) to observe the actual behavior. If the test program attempts an unsafe operations, the validation system generates an alert identifying the instruction that attempted the unsafe operation as well as indicating the presence of an issue (e.g., a bug) in the static analysis tool.

### BACKGROUND

In the realm of computer science and software engineering, static analysis (also known as static program analysis) is an evaluation of a computer program that is performed without executing the computer program. In general, the term static analysis refers to analysis that is performed by an automated tool, as opposed to human analysis (e.g., “program understanding”). As such, the sophistication and complexity of a static analysis tool can vary greatly between various tools. For instance, a first static analysis tool may evaluate the behavior of individual statements (e.g., instructions) while a second static analysis tool may model the full behavior of a computer program with respect to its source code. Consequently, static analysis tools can be utilized in a wide variety of technical contexts from detecting simple coding errors to mathematically proving various properties about a given computer program.

In this way, many modern software systems rely upon static analysis tools to verify the safety and/or correctness of computer programs prior to execution. That is, the static analysis tool identifies a given computer program as either safe for execution or unsafe for execution. As such, it is important for static analysis tools to operate free of errors (e.g., bugs) such that their classifications of computer programs are accurate and can be trusted. This is especially true for software systems operating in a privileged context (e.g., an operating system kernel) and/or safety-critical systems (e.g., medical software, aviation software).

It is with respect to these and other considerations that the disclosure made herein is presented.

### SUMMARY

The techniques presented herein provide a system for validating a static analysis tool by utilizing a comparison between an abstract state computed by the static analysis tool and a concrete state output by a concrete implementation. In addition, the system includes infrastructure for generating rigorous test computer programs (may be referred to herein as “test programs”) for validating static analysis tools. Within the context of the present disclosure, a static analysis tool is an automated software tool that evaluates the behavior of a given computer program without executing the program. As such, the static analysis tool implements a mathematical model (e.g., abstract interpretation) for analyzing the behavior of the computer program. In contrast, a concrete implementation is an “actual” machine (e.g., a virtual machine) that executes the given computer program to observe the behavior of the computer program.

In various examples, the system includes components that generate a test program for evaluating various aspects of a static analysis tool. As will be elaborated upon below, the test program can be generated in various ways. In one example, a test program can be generated using a machine learning model implementing an evolutionary algorithm. In another example, a test program can be generated using a generative language model using natural language documentation associated with the static analysis tool. Generally described, the test program is a sequence of instructions (e.g., bytecode instructions, functions) that perform the aforementioned operations such as arithmetic and memory accesses. In addition, the test program can also include a dataset for initializing the test program in the case of the concrete implementation. Moreover, in the case of the concrete implementation, the test program can be instrumented such that a current state of the test program is output at various stages of execution (e.g., at each instruction).

The operations defined by the sequence of instructions can be one of a safe operation or an unsafe operation. Within the context of the present disclosure, a safe operation is generally any operation that does not cause the program to crash, hang, or otherwise interfere with normal operations (e.g., a predefined percentage degradation in system performance such as ten percent). As such, an unsafe operation is any operation that causes a crash, a hang, or an interference with normal operations, as well as operations that attempt actions that are forbidden and/or undefined (e.g., attempting to access an out-of-bound memory address).

Accordingly, the system provides a test program to both the static analysis tool and the concrete implementation for analysis. As mentioned, the static analysis tool computes an abstract state of a test program under analysis without executing the test program. More specifically, the static analysis tool computes an abstract state of the test program at each instruction within the sequence of instructions. Stated another way, the abstract state is updated at each step of the test program to track possible behaviors of the test program. In a particular example, a static analysis tool utilizing abstract interpretation can define a range of expected values at each instruction of the test program (e.g., variables, register values, shared memory values). Based on the abstract state, the static analysis tool can classify the test program as either a safe program or an unsafe program. Stated another way, the static analysis tool verifies the test program for execution or prevents (e.g., rejects) the test program from execution.

Conversely, the concrete implementation (e.g., a virtual machine, a native machine) loads, initializes, and executes the test program to obtain a concrete state that expresses the actual behavior of the test program under “real” conditions. As mentioned, the test program can be instrumented to output the concrete state at each instruction to enable the comparison between the abstract state and the concrete state. As such, where an abstract state can define an expected value and/or a range of expected values, the concrete state includes a specific value resulting from executing the test program.

The abstract state can then be compared against the concrete state at each instruction to detect mismatches indicating an issue in either the static analysis tool or the concrete implementation. For example, for a specific instruction of a given test program, the static analysis tool may compute an abstract state in which a variable (e.g., “y”) can be any positive integer. If, for the same instruction of the test program, the concrete state computed by the concrete implementation is a negative integer, the system can flag the mismatch as indicative of an issue (e.g., a bug).

In response, the system generates an alert that identifies the instruction of the test program that caused the mismatch between the abstract state and the concrete state. In various examples, the alert is provided to a responsible entity, such as a developer, associated with the static analysis tool to provide insight and help diagnose the specific issues causing the mismatch. For instance, the test program, based on the semantics and arrangement of its instructions, can have an expected behavior. In a specific example, the test program performs an arithmetic operation using two numerical values (e.g., addition, subtraction). As such, if one of the abstract or the concrete state violate this expected behavior it follows that the issue causing the mismatch lies with the static analysis tool or the concrete implementation respectively.

Following execution of the test program, the system can then proceed to generate a new iteration of the test program having a sequence of instructions that expands on the operations of the previous iteration. In a simple example, if the original test program involved truncating a 64-bit number to 32-bits, the new iteration of the test program can use the truncated number in an arithmetic operation (e.g., signed division). Consequently, successive iterations of test programs progressively increase in complexity and test increasingly more aspects of the static analysis tool. In this way, the system can perform a thorough evaluation of the static analysis tool thereby enhancing reliability.

In another technical benefit of the present disclosure, utilizing both the abstract state and the concrete state to validate the static analysis tool streamlines the process of discovery, diagnosing, and addressing issues within the static analysis tool. For example, in the system presented herein, a mismatch between the abstract state and the concrete state is a definite indication of at least one issue. Moreover, updating the abstract state and the concrete state on a per-instruction basis enables the system to identify specific operations that cause these issues. In this way, a developer can quickly replicate the issue and identify the root cause via a targeted investigation rather than a protracted process of rediscovering the issue.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 is a block diagram of an example system for validating a static analysis tool via a comparison against a concrete implementation executing a generated test program.

FIG. 2A illustrates one example of a static analysis tool utilizing abstract interpretation to evaluate a test program.

FIG. 2B illustrates an example comparison between the abstract state of the example static analysis tool and a concrete implementation executing the test program.

FIG. 3 illustrates additional technical details of the information included in an example concrete state output.

FIG. 4 illustrates an example of diagnosing an issue arising from a mismatch between the abstract state and the concrete state.

FIG. 5 is a block diagram of an example system for generating a test program for validating a static analysis tool.

FIG. 6 is a block diagram of an example system for generating an expanded test program for validating a static analysis tool.

FIG. 7A illustrates an example system utilizing a machine learning model implementing an evolutionary algorithm to generate a first iteration of a test program.

FIG. 7B illustrates an example system utilizing a machine learning model implementing an evolutionary algorithm to generate a second iteration of a test program.

FIG. 8 illustrates an example system utilizing a generative language model to generate a test program based on natural language documentation.

FIG. 9 is a flow diagram showing aspects of an example process for generating and evaluating a test program for validating a static analysis tool.

FIG. 10 is a computer architecture diagram illustrating an illustrative computer hardware and software architecture for a computing system capable of implementing aspects of the techniques and technologies presented herein.

### DETAILED DESCRIPTION

The techniques presented herein provide a system for validating a static analysis tool by utilizing a comparison between an abstract state computed by the static analysis tool and a concrete state output by a concrete implementation. In addition, the system includes components for generating rigorous test programs for validating static analysis tools. As mentioned above, a static analysis tool is an automated software tool that evaluates the behavior of a given computer program without executing the program. As such, the static analysis tool implements a mathematical model (e.g., abstract interpretation) for analyzing the behavior of the computer program. In contrast, a concrete implementation is an “actual” machine (e.g., a virtual machine) that executes the given computer program to observe the behavior of the computer program.

In addition, static analysis tools are used across a wide variety of software analysis contexts from assisting developers in debugging code to evaluating safety-critical software systems. In a specific example of static program analysis, a static analysis tool is utilized to verify a computer program prior to execution as part of a suite of technologies referred to as “BPF” (formerly known as Berkeley Packet Filter or classic BPF), or more accurately, “eBPF” (Extended BPF). Generally described, eBPF enables developers to execute programs in a privileged environment such as an operating system kernel. In this way, eBPF is used to efficiently extend the capabilities of the kernel at runtime without requiring modifications to the kernel source code or loading additional kernel modules. Therefore, eBPF is frequently utilized for implementing functionality directed to networking, security, and observability due to the operating system's privileged position to oversee and control a computing system. Consequently, eBPF is utilized in a wide variety of uses cases including networking and load-balancing in modern data centers, extracting fine-grained security data, providing observability for tracing applications during execution, performance troubleshooting, and so forth.

By allowing user-supplied programs to be executed directly in the kernel, eBPF increases the flexibility and efficiency of deploying customized logic. However, eBPF also introduces a wide attack surface. Malicious eBPF programs may try to exploit the privileged position of the eBPF subsystem in the kernel. Accordingly, eBPF can utilize a verifier that is tasked with determining the safety of computer programs. In a specific example, the verifier utilizes a static analysis-based approach to determining this safety. As such, while the examples discussed herein are presented within the context of eBPF, it should be understood that these techniques can be utilized in any static analysis domain for which a test computer program can be generated.

Due to broad utilization and reliance on static analysis tools, it is important that such tools perform accurately and produce trustworthy outputs. That is, as a tool for analyzing and identifying potential issues in computer programs, it is important that the static analysis tools themselves be free of errors (e.g., bugs). However, conventional methods for validating static analysis tools, such as manually writing test programs and differential comparisons between implementations, can be highly labor intensive, imprecise, and incomplete. Consequently, there is a need for well-defined and repeatable methods for validating static analysis tools.

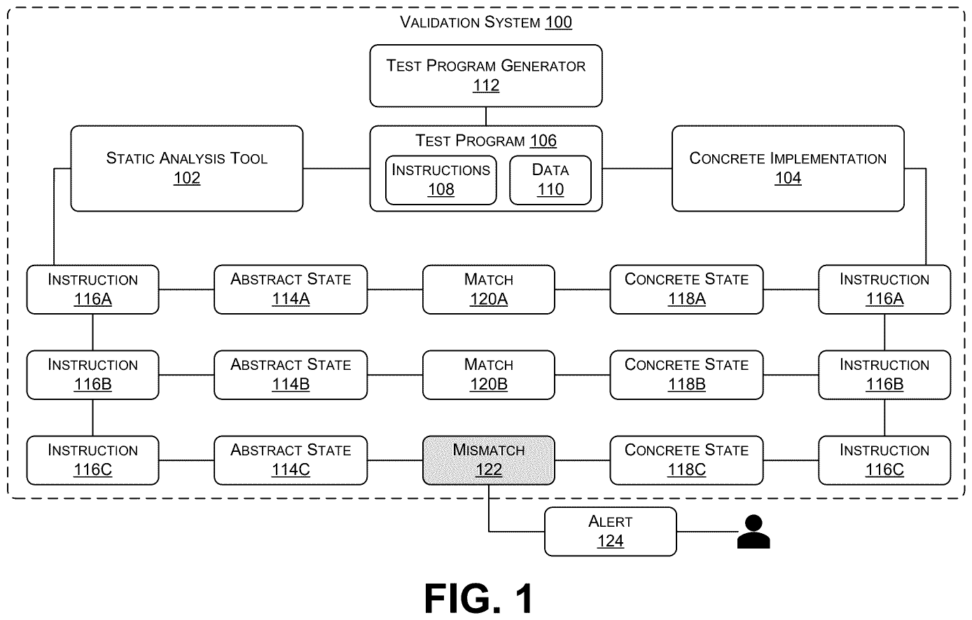

Various examples, scenarios, and aspects related to the techniques are described below with respect to FIGS. 1-10.

FIG. 1 illustrates a validation system 100 for validating a static analysis tool 102 against a concrete implementation 104 using a test program 106. As shown, the test program 106 comprises a sequence of instructions 108 and data 110 for initializing the test program 106. In various examples, the instructions 108 of the test program 106 perform various operations (e.g., arithmetic) to express behaviors of the static analysis tool 102 and the concrete implementation 104. Generally described, the static analysis tool 102 is an automated software tool that evaluates the behavior of a given test program 106 without actually executing the test program 106. As such, the static analysis tool 102 can implement a mathematical model (e.g., abstract interpretation) for analyzing the behavior of the test program 106. In contrast, the concrete implementation 104 is an “actual” machine (e.g., a virtual machine, a native machine) that executes the given computer program to observe the behavior of the test program 106 under “real” conditions.

In various examples, the test program 106 (i.e., the sequence of instructions 108 and the data 110) is automatically generated by a test program generator 112. Generally described, the test program generator 112 is an automated tool that is configured to generate a test program 106 in accordance with various technical requirements. For example, in the context of eBPF, test program generator 112 generates a test program 106 in which the instructions 108 are a sequence of BPF bytecode instructions. In another example, the instructions 108 are functions defined in a programming language such as “C”. As will be described further below, the test program generator 112 can utilize various tools to generate test programs 106. For example, the tools include a machine learning model implementing an evolutionary algorithm, a generative language model, or another suitable mechanism.

The validation system 100 provides the test program 106 to the static analysis tool 102 for analysis and to the concrete implementation 104 for execution. As mentioned above, the static analysis tool 102 does not execute the test program 106 per se but rather analyzes the behavior of the test program 106 over a variety of possible inputs or all possible inputs. More specifically, the static analysis tool 102 computes an abstract state 114A-114C for each instruction 116A-116C of the sequence of instructions 108. In general, an individual abstract state 114A defines expected values for one or more aspects of the test program 106 at the corresponding instruction 116A (e.g., variables, register values, shared memory values). Stated another way, the abstract state 114A defines values that the static analysis tool 102 identifies as valid for the corresponding instruction 116A. In a specific example, the static analysis tool 102 implements an abstract interpretation techniques in which an abstract state 114A defines a valid range of expected values at the corresponding instructions 116A.

Conversely, the concrete implementation 104 initializes and executes the test program 106 to compute a concrete state 118A-118C for each instruction 116A-116C of the sequence of instructions 108. Whereas an abstract state 114A defines an expected value at the instruction 116A, the concrete state 118A is as “real” value that is obtained from performing the operations defined by the sequence of instructions 108. In various examples, the test program 106 is instrumented to cause the concrete implementation 104 to output a concrete state 118A-118C at each instruction 116A-116C. Stated another way, the test program 106 causes the concrete implementation 104 to output a concrete state 118A at each stage of execution.

Accordingly, the abstract states 114A-114C are compared against the concrete states 118A-118C at each of the instructions 116A-116C. As shown in FIG. 1, comparing the abstract state 114A and the concrete state 118A results in a match 120A. Likewise, the abstract state 114B and the concrete state 118B also match 120B. In one example, the abstract state 114A and the concrete state 118A can be said to match if the expected value defined by the abstract state 114A is equal to the specific value defined by the concrete state 118A. In some instances, values can be rounded to a certain decimal and if the rounded values match then the initial values (before the rounding) do not have to be an exact match. In another example, the abstract state 114A and the concrete state 118A can be said to match if the range of values defined by the abstract state 114A contains the specific value defined by the concrete state 118A.

However, comparing the abstract state 114C and the concrete state 118C results in a mismatch 122. In contrast to a match 120A or 120B, the abstract state 114C and the concrete state 118C can be said to mismatch if the expected value defined by the abstract state 114C is not equal to the specific value defined by the concrete state 118C. Alternatively, the abstract state 114C and the concrete state 118C can be said to mismatch if the range of values defined by the abstract state 114C does not contain the specific value defined by the concrete state 118C. As mentioned above, a mismatch 122 between the abstract state 114C and the concrete state 118C is indicative of an issue (e.g., a bug) in one of the static analysis tool 102 or the concrete implementation 104. Accordingly, the validation system 100 generates an alert 124 in response to the mismatch 122 and provides the alert 124 to a developer or other human agent to inform debugging efforts. In various examples, the alert 124 can (1) identify the instruction 116C that caused the mismatch 122 and (2) indicate that an issue exists in one of the static analysis tool 102 or the concrete implementation 104. By uncovering issues in this way, the validation system 100 provides well-defined and specific insights into the behavior of the static analysis tool 102 that streamline the process of identifying and resolving bugs.

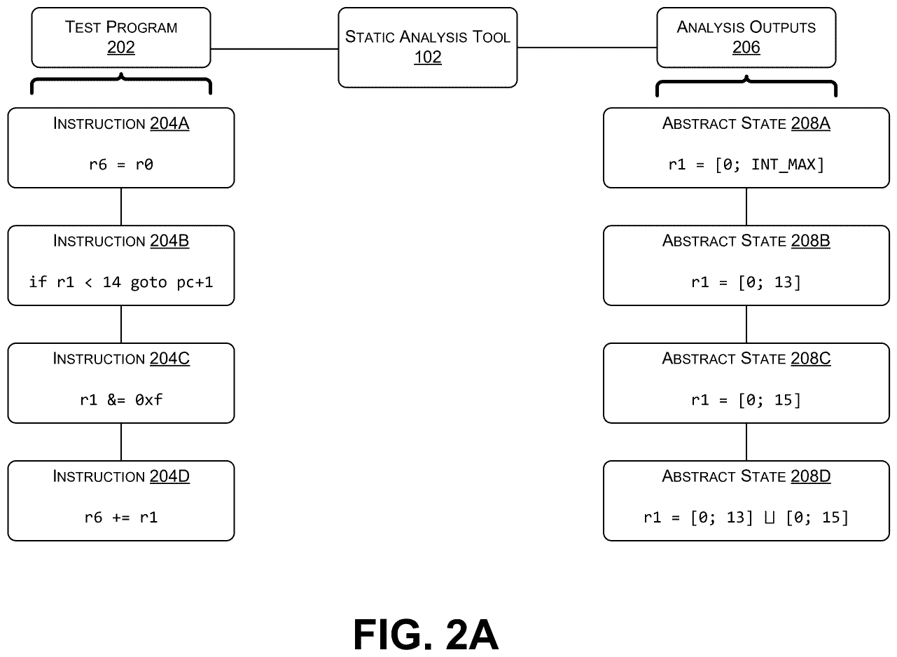

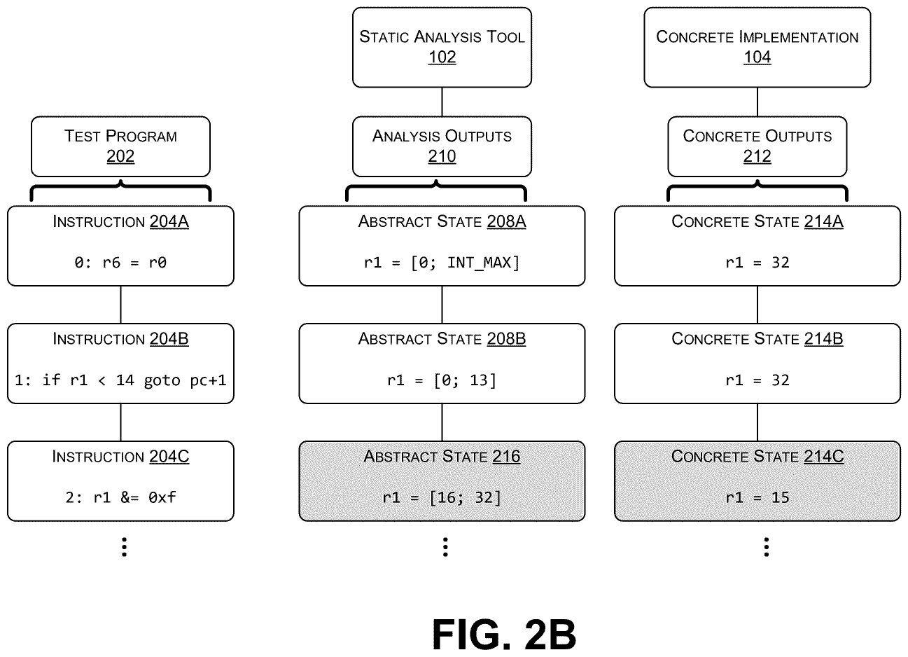

Turning now to FIG. 2A, a specific example of abstract interpretation in a static analysis tool 102 is shown and described with respect to a test program 202. Generally described, abstract interpretation is a specific technique for static analysis that discovers a given computer program's behavior over a variety of possible inputs or all possible inputs. However, since identifying every possible permutation of program behavior is not computable within finite time and memory (e.g., the halting problem), abstract interpretation instead provides a sound approximation of program behavior based on the semantics of its instructions. In general, a static analysis tool is sound if every finding produced by the static analysis tool is correct. That is, the static analysis tool is sound if it does not assert a property to be true when it is not true. In addition, the abstract interpretation is approximate in that it does not compute a program behavior for every possible iteration of a given computer program. Rather, such algorithms limit analysis to reachable program states. For example, if a given variable “x” is defined by a given computer program as a positive number (e.g., “x>0”), an algorithm of static analysis will not consider program states in which the value of the variable “x” is a negative number. In this way, abstract interpretation renders the challenge of static program analysis amenable to automatic computation.

Consider a test program 202 that comprises a sequence of instructions 204A-204D that calculates a location for a memory access defined by r0+r1 where r0 is a pointer to a map value and r1 is an offset within the map value at which to read the data. At the first instruction 204A, a register “r6” is initialized with the value of the pointer stored in another register “r0”. Accordingly, the static analysis tool 102 produces an analysis output 206 including an abstract state 208A corresponding to the first instruction 204A. For the sake of discussion and brevity, the abstract state 208A is only concerned with the value stored in a register “r1”. However, it should be understood that any number of values can be described by an abstract state 208A. As the register “r1” is not yet initialized, the value of the variable r1 can be any positive value. Accordingly, the abstract state 208A defines r1 using an abstract value ranging from zero to INT_MAX.

Next, at instruction 204B, the test program 202 checks if the value of r1 is bounded. If the value of r1 is not bounded, the test program 202 proceeds to instruction 204C in which the value of r1 is bound with a bitmask. If the value of r1 is bounded, then the test program 202 proceeds to instruction 204D to calculate the location of the memory access. That is, the instruction 204B is a logical condition that represents two possible paths (“is the value of r1 less than fourteen?”). In one possible path, the value of r1 is less than fourteen (e.g., the condition is true) and thus the abstract state 208B at instruction 204B defines the abstract value of r1 as ranging from zero to thirteen. Conversely, in the other possible path, the value of r1 is greater than fourteen and thus proceeds to instruction 204C. Accordingly, the abstract state 208C at the instruction 204C defines the abstract value of r1 as ranging from zero to fifteen due to the bitmask (0xf).

Finally, at instruction 204D, the test program 202 sums the values of r6 and r1 to build the location of the memory access. As such, the abstract state 208D defines the abstract value of r1 as a logical join between the abstract values of r1 from the abstract states 208B and 208C. That is, rather than continue analyzing both possible paths of the logical condition at instruction 204B, the static analysis tool 102 computes an abstract value that captures the range of possible values stemming from both paths.

Turning now to FIG. 2B, consider a modified continuation of the example described above with respect to FIG. 2A. The present example utilizes the same test program 202 with instructions 204A-204C shown. Likewise, the static analysis tool 102 produces an analysis output 210 with the same abstract states 208A and 208B described above. Now, a concrete implementation 104 is configured to execute the test program 202. As shown, the concrete implementation 104 produces a concrete output 212 comprising concrete states 214A-214C for each corresponding instruction 204A-204C. As shown, the value of r1, when executed by the concrete implementation 104 is initialized to thirty-two. Thus, the concrete states 214A and 214B show the specific value of r1 as thirty-two. Since thirty-two is greater than fourteen, the test program 202 proceeds to instruction 204C in which the value of r1 is masked with 0xf or fifteen. Accordingly, the concrete state 214C defines the specific value of r1 as fifteen. However, now the static analysis tool 102 computes an abstract state 216 that does not comport with the logic expressed by the test program 202 defining an abstract value of r1 ranging from sixteen to thirty-two. As such, the abstract state 216 and the concrete state 214C are shown to mismatch thereby indicating an issue in one of the static analysis tool 102 or the concrete implementation 104. From an intuitive understanding of the sequence of instruction 204A-204C, one would be correct in identifying the static analysis tool 102 as the source of the issue. Accordingly, a developer can investigate the static analysis tool 102 to troubleshoot the root cause of the incorrect evaluation of the abstract state 216.

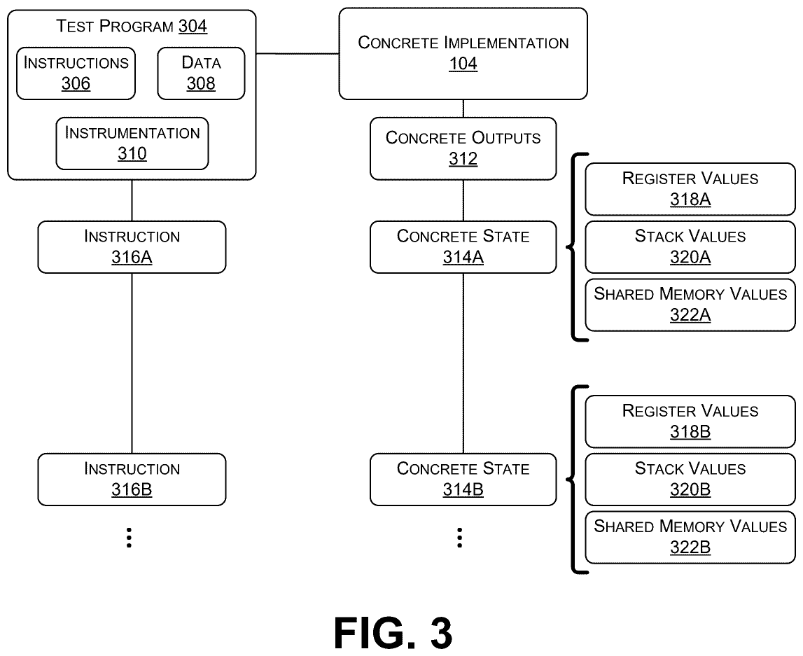

Proceeding now to FIG. 3, additional technical details are illustrated with respect to the concrete outputs 302 of a concrete implementation 104 executing a test program 304. As mentioned above, the test program 304 includes a sequence of instructions 306 that perform various operations (e.g., arithmetic) and data 308 that enables the concrete implementation 104 to initialize the test program 304. In addition, the test program 304 includes instrumentation 310 that causes the concrete implementation 104 to produce concrete outputs 302 while executing the test program 304. That is, the instrumentation 310 is additional code (e.g., instructions) that is ancillary to the sequence of instructions 306.

As described above, the concrete implementation 104 computes concrete states 312A and 312B for each instruction 314A and 316B of the test program 304. In general, the state of the test program 304 is defined by its variables which represent locations in memory and the contents of these memory locations at a given point in the execution of the test program 304 (e.g., at instruction 314A). Accordingly, the concrete states 312A and 312B, expose the values of these variables at each instruction 314A and 314B of the test program 304. More specifically, an individual concrete state 312A can include register values 316A, stack values 318A, and shared memory values 320A. As different types of computer memory, the register values 316A, stack values 318A, and shared memory values 320A collectively define the concrete state 312A of the test program 304 at the stage of execution defined by the instruction 314A. Likewise, the concrete state 312B exposes register values 316B, stack values 318B, and shared memory values 320B following execution of the instruction 314B. In this way, the concrete implementation 104 provides granular visibility into the actual behaviors of the test program 304 at each stage of execution (e.g., instructions 314A and 314B) and enables accurate comparisons for validating a static analysis tool.

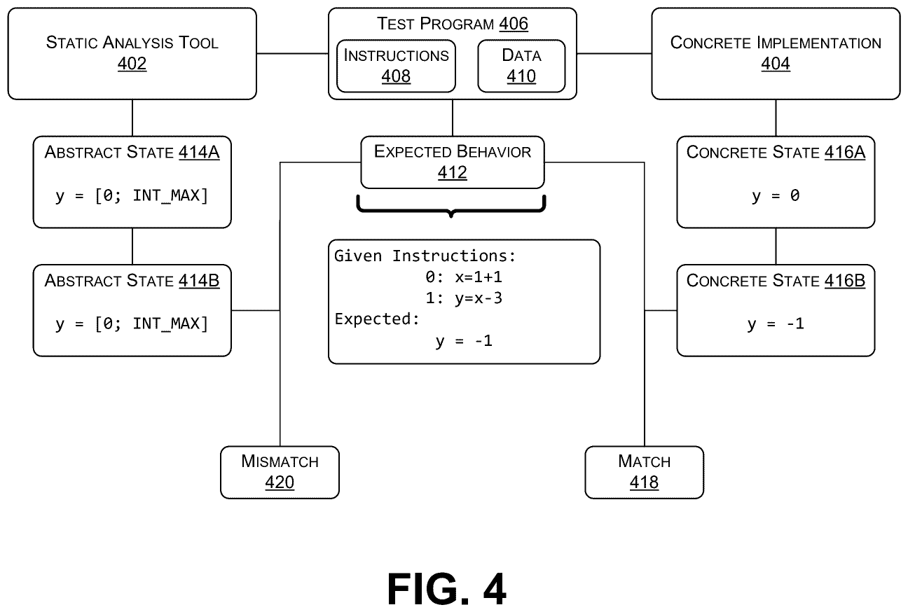

Turning now to FIG. 4, an example of identifying one of a static analysis tool 402 or a concrete implementation 404 as the source of an issue is shown and described. As described above, the static analysis tool 402 is validated via a comparison against a concrete implementation 404 executing a test program 406 that is provided to both the static analysis tool 402 and the concrete implementation 404. Accordingly, the test program 406 includes a sequence of instructions 408 and data 410 for initializing the test program 406. In addition, an expected behavior 412 is derived from the semantics of the instructions 408. As shown, given two instructions 408 in which a first variable “x” is defined as “1+1” and a second variable “y” is defined as “x−3”, the expected behavior 412 is “y=−1”. Or, more generally, the expected behavior 412 is that the variable “y” is a negative number.

Accordingly, the static analysis tool 402 computes an abstract state 414A and 414B for each of the two instructions 408 while the concrete implementation 404 computes a concrete state 416A and 416B for each of the two instructions 408. In the first abstract state 414A, the value of the variable “y” is undefined. As such, the abstract value of the variable “y” is defined by the static analysis tool 402 as any positive integer. In the case of the concrete implementation 404, consider that the data 410 initializes the value of the variable “y” to “0”. Accordingly, the value of the variable “y” in the first concrete state 416A is “0”. At this point in the test program 406, the abstract state 414A computed by the static analysis tool 402 is said to match the concrete state 416A computed by the concrete implementation 404.

However, upon proceeding to the second abstract state 414B, the static analysis tool 402 appears to maintain the abstract value of the variable “y” as any positive integer. Conversely, the value of the variable “y” in the second concrete state 416B is changed to “−1” following execution of the second instruction “y=x−3”. In this way, it can be said that the abstract state 414B and the concrete state 416B mismatch, indicating an issue (e.g., a bug) in one of the static analysis tool 402 or the concrete implementation 404. Accordingly, the behaviors of the static analysis tool 402 and the concrete implementation 404 are compared against the expected behavior 412 to identify the source of the issue. As such, the concrete state 416B is shown to match 418 the expected behavior 412 while the abstract state 414B is shown to mismatch 420 the expected behavior 412 thereby indicating that the static analysis tool 402 is the source of the issue.

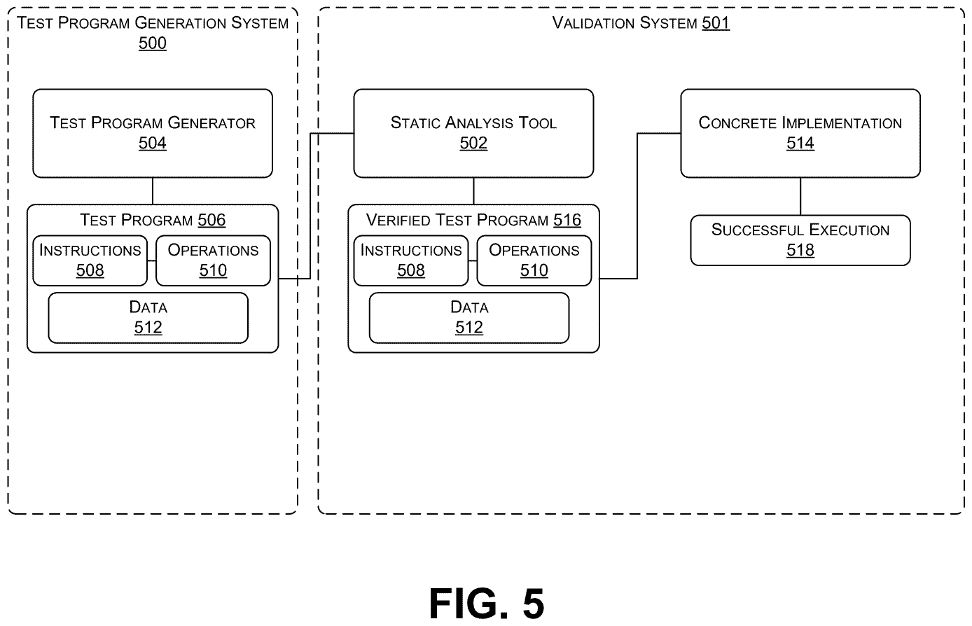

Turning now to FIG. 5 aspects of a test program generation system 500 are shown and described. As mentioned above, the test program generation system 500 can be deployed in a validation system 501 for evaluating the behavior of a static analysis tool 502. Accordingly, the test program generation system 500 utilizes an automated test program generator 504 to produce a test program 506 comprising a sequence of instructions 508 that perform various operations 510 (e.g., arithmetic). More specifically, the sequence of instructions 508 perform operations 510 that touch on various aspects of the static analysis tool 502, such as its ability to evaluate truncation of 64-bit numbers to 32-bits, signed division of truncated 64-bit numbers, and so forth. In addition, the test program 506 includes data 512 for initializing the test program 506 when executed by a concrete implementation 514. In a specific example, the test program 506 is a BPF program in which the instructions 508 are BPF bytecode instructions. However, it should be understood that the test program generator 504 can be configured to generate the test program 506 for any suitable specification and/or programming language.

As described, the static analysis tool 502 is an automated tool for verifying the safety of an incoming computer program prior to execution. Generally, verification involves detecting whether the sequence of instructions 508 performs any operations 510 that would cause instability, errors, or otherwise compromise the security of a computer system during execution. Accordingly, the static analysis tool 502 analyzes the test program 506 and can classify the test program 506 as either safe or unsafe. In the present example, the static analysis tool 502 classifies the test program 506 as safe resulting in a verified test program 516. Conversely, if the static analysis tool 502 identified one or more unsafe operations, the test program 506 is rejected. The verified test program 516 is then executed by the concrete implementation 514. Subsequently, the concrete implementation 514 completes execution of the verified test program 516 and generates an output indicating a successful execution 518 that was free of errors. In various examples, the successful execution output 518 can include diagnostic data to enable an external entity such as a developer to verify the results.

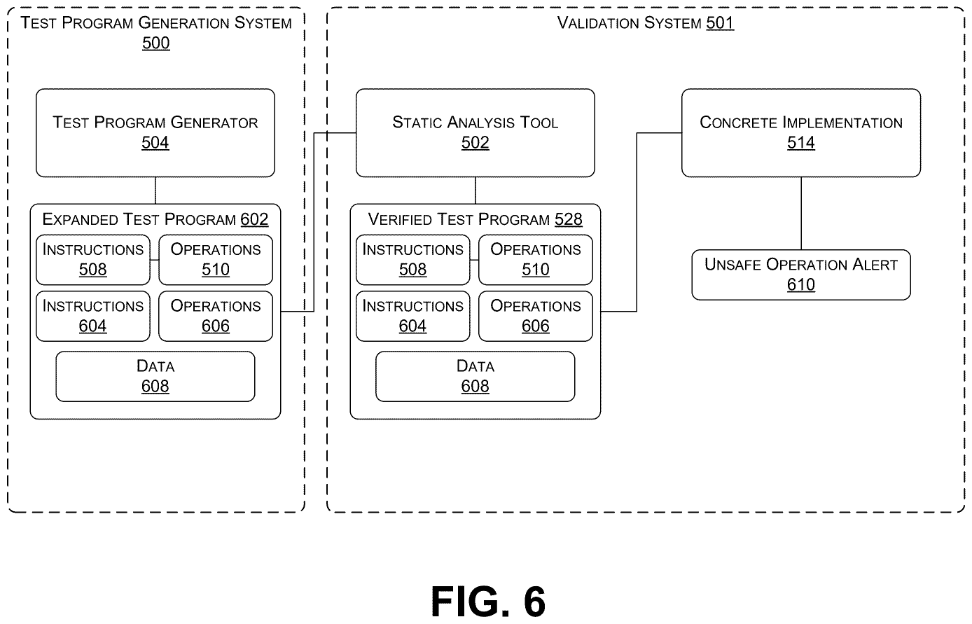

Proceeding now to FIG. 6, following successful execution of the original test program 506, test program generator 504 subsequently generates an expanded test program 602. As shown, the expanded test program 602 includes the sequence of instructions 508 from the previous test program 506 and a new sequence of instructions 604 the perform new operations 606 in addition to the operations 510 of the previous test program 506. Accordingly, the expanded test program 602 also includes a new set of data 608 to support the additional sequence of instructions 604. In this way, where the original test program 506 operated on a first aspect of the static analysis tool 502, the expanded test program 602 operates on a second aspect of the static analysis tool 502. Stated another way, the test program generation system 500 generates a test program 506 as well as subsequent iterations of the test program (e.g., the expanded test program 602) that gradually grow to test more of the functionality of the static analysis tool 502. As such, the test program generation system 500 continues to generate test program iterations until a test program that is classified as safe is found to be unsafe during execution.

Accordingly, the static analysis tool 502 can analyze and classify the expanded test program 602 as a verified test program 610. However, upon execution by the concrete implementation 514, the new instructions 604 of the expanded test program 602 are found to have attempted operations 606 that violate safety constraints of the concrete implementation 514 (e.g., an unsafe operation). As mentioned, an unsafe operation is any operation that causes an error, instability, or otherwise compromises the security of a computing system. That is, an unsafe operation is not necessarily a malicious operation. Rather, an unsafe operation is one that violates safety constraints of a technical specification to which the static analysis tool 502 and the concrete implementation 514 conform (e.g., BPF).

That is, it can be said that the evaluation of the expanded test program 602 by the static analysis tool 502 mismatches that of the concrete implementation 514. In response, the concrete implementation 514 generates an unsafe operation alert 612. Similar to the examples discussed above, the unsafe operation 612 indicates an issue (e.g., a bug) in one of the static analysis tool 502 or the concrete implementation 514. In various examples, the unsafe operation alert 612 identifies one of the instructions 604 that attempted the unsafe operation 606 and/or one or more preceding ones of the instructions 604 to provide context as to how and/or why the unsafe operation occurred.

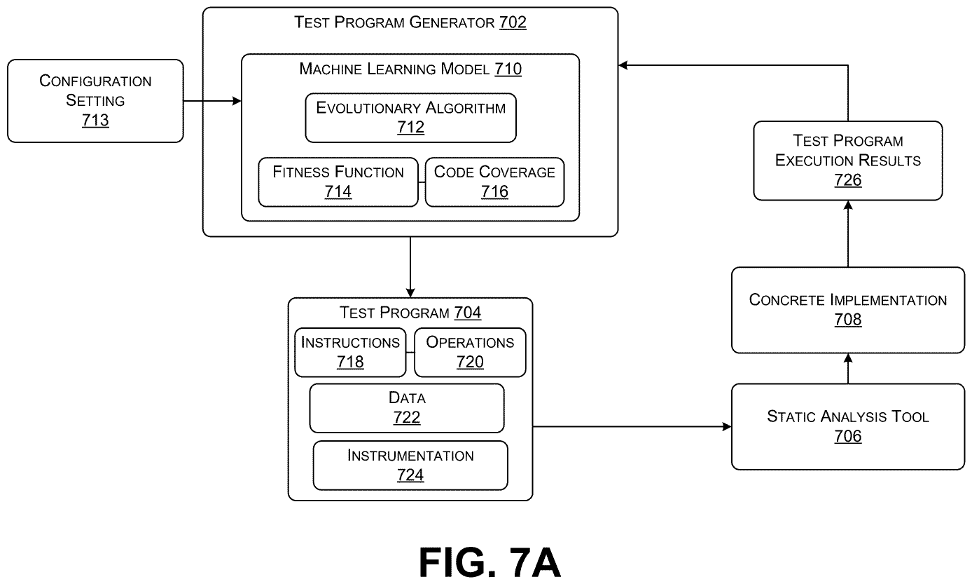

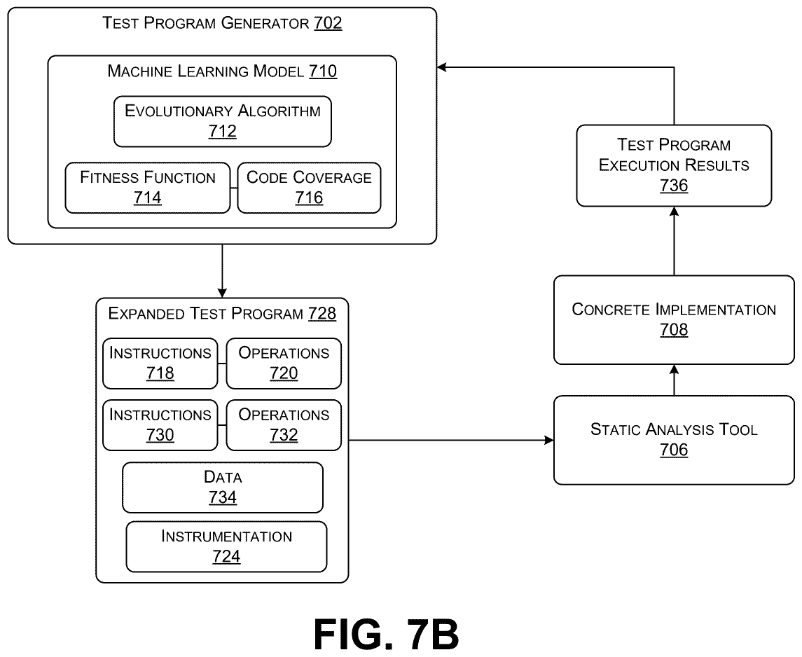

Turning now to FIG. 7A, technical aspects of an example test program generator 702 are shown and described. As mentioned briefly, a test program generator 702 is an automated tool for generating a test program 704 for validating a static analysis tool 706 against a concrete implementation 708 executing the test program 704. To that end, the test program generator 702 can utilize various automated technologies for generating the test program 704. In the example of FIG. 7A, the test program generator 702 utilizes a machine learning model 710 implementing an evolutionary algorithm 712 such as a genetic algorithm, genetic programming, and/or differential evolution. However, the machine learning model 710 can be any of a broad range of models that can be trained to produce outputs by observing properties of past interactions. For instance, the machine learning model 710 may be a neural network, a support vector machine, a decision tree, a clustering algorithm, or any other suitable model. In some cases, the machine learning model 710 can be trained using labeled training data, a reward function, or other mechanisms, and in other cases, the machine learning model 710 can learn by analyzing data without explicit labels or rewards.

In the present example, the machine learning model 710 is configured to output malformed and/or unpredictable inputs to a system (e.g., the static analysis tool 706) to detect security issues, bugs, and/or system failures (e.g., fuzzing). In various examples, the machine learning model 710 is initialized with a configuration setting 713 which can include an output language, examples of valid and/or invalid inputs, user-supplied dictionaries comprising language keywords, and the like. Consequently, training the machine learning model 710 comprises processing an output of the machine learning model 710 (e.g., the test program 704) in the manner described above with respect to FIGS. 5 and 6 and inputting the results to the machine learning model 710 to cause the machine learning model 710 to generate a new iteration of the output (e.g., the expanded test program discussed below). In a specific example, the machine learning model 710 is the open source LIBFUZZER from LLVM. However, it should be understood that any suitable code generation and/or fuzzing tool can be utilized such as AMERICAN FUZZY LOP.

Generally described, the evolutionary algorithm 712 is a computational algorithm utilizing mechanisms inspired by biological evolution, such as reproduction, mutation, recombination, and selection. As such, for a given optimization problem (e.g., generating test programs 704), candidate solutions to the optimization problem represent individuals in a population, and a fitness function 714 determines the quality of the candidate solutions. In the present example, the fitness function 714 evaluates the candidate solutions with respect to a code coverage 716 of the static analysis tool 706 and/or the concrete implementation 708. That is, successive iterations of the test program 704 operate on increasingly more aspects of the static analysis tool 706 and/or the concrete implementation 708. Moreover, leveraging code coverage of the concrete implementation 708 in addition to the static analysis tool 706 enables the machine learning model 710 to iteratively evolve the data 722 for initializing the test program 704 in addition to the instructions 718. In this way, the test program generator 702 enables thorough test coverage that ensures a degree of bug discovery that is often infeasible with manual test program creation.

For example, consider a first iteration of the test program 704 that includes a sequence of instructions 718 that perform operations 720 on various aspects of the static analysis tool 706. In addition, the test program 704 includes data 722 for initializing the test program 704 as well instrumentation 724 for providing visibility during execution by the concrete implementation 708. In various examples, the data 722 and/or the instrumentation 724 is generated by the machine learning model 710 in conjunction with the instructions 718. Alternatively, the data 722 and/or the instrumentation 724 is generated by a separate automated tool (e.g., a conventional code generation tool).

Following the analysis and execution of the test program 704, test program execution results 726 can be extracted and provided to the test program generator 702. In one example, the test program execution results 726 indicate that the static analysis tool 706 correctly verified the test program 704 and that the concrete implementation 708 executed the test program 704 without errors. Conversely, the test program execution results 726 may indicate that despite passing verification by the static analysis tool 706 one or more of the operations 720 of the test program 704 were unsafe indicating an issue in one of the static analysis tool 706 or the concrete implementation 708. Accordingly, such issues can be addressed prior to the next stage of testing. In this way, the test program execution results 726 assist developers in identifying and addressing issues as well as inform subsequent iterations of the test program 704. That is, the program execution results 726 serve as an additional input to the machine learning model 710 that enables fine tuning and/or additional learning during normal operations.

Turning now to FIG. 7B, the test program generator 702 generates an expanded test program 728 that extends the previous iteration of the test program 704 in accordance with the evolutionary algorithm 712 and the fitness function 714 to increase code coverage 716. As such, the expanded test program 728 includes additional instructions 730 that perform new operations 732 in addition to the operations 720 of the previous iteration. In addition, the expanded test program 728 includes an updated set of data 734 for initialization. Accordingly, a new set of test program execution results 736 is generated following verification by the static analysis tool 706 and execution by the concrete implementation 708. In this way, the test program generator 702 generates iteratively more complex test programs that gradually cover all aspects of the static analysis tool 706.

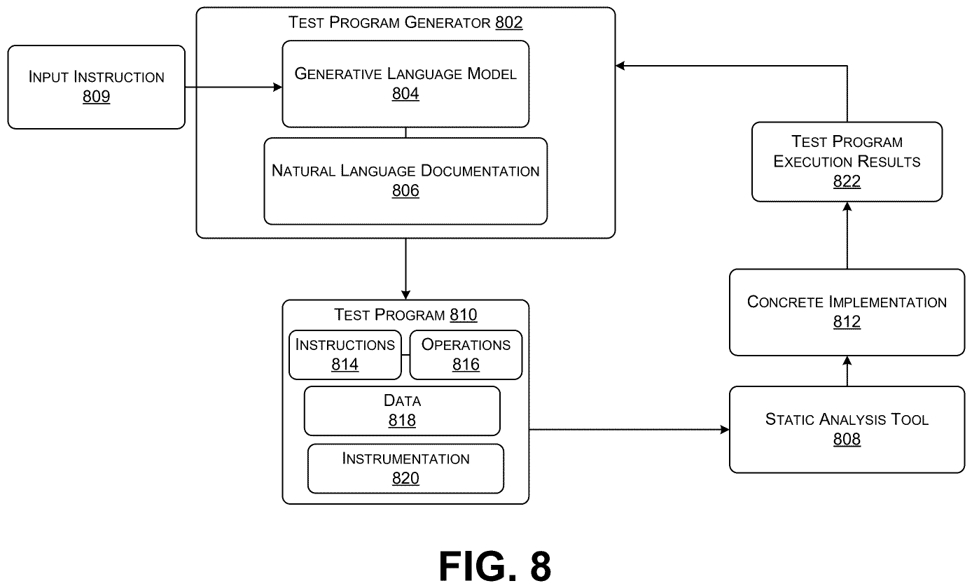

Proceeding to FIG. 8 aspects of an alternative example of a test program generator 802 are shown and described. In the present example, the test program generator 802 utilizes a generative language model 804 that receives natural language documentation 806 associated with a static analysis tool 808 (e.g., a human-readable technical specification, a human-readable user guide) and an input instruction 809. Within the context of the present disclosure, the input instruction 809 refers to an input provided to the generative language model 804 that causes the generative language model 804 to produce an output. Moreover, the input instruction 809 can be provided in various modalities, such as text, image, audio, video, and the like. In a specific example, the input instruction 809 is a statement (e.g., a language generation prompt) commanding the generative language model 804 to “generate a test program based on the provided documentation”.

Accordingly, the input instruction 809 causes the generative language model 804 to output a test program 810 for validating the static analysis tool 808 against a concrete implementation 812. Sometimes referred to as large language models, small language models, or other monikers, the generative language model 804 is a computational model implementing a statistical representation of natural language. As such, the generative language model 804 is trained on large amounts of text data, image data, and/or other data to learn statistical relationships between individual tokens (e.g., words, characters, phrases). Consequently, the generative language model 804 achieves predictive capability with respect to vague and/or typically nebulous aspects inherent to natural language such as syntax, semantics, and ontologies. The learning enables the generative language model 804 to output a coherent test program 810 that adheres to the functional requirements defined by the natural language documentation 806. Moreover, as generative language models 804 are typically pretrained (e.g., a generative pretrained transformer), an operator of the test program generator 802 can utilize the generative language model 804 without undergoing a complex training process.

The generative language model 804 can be implemented as a neural network, e.g., a long short-term memory-based model, a decoder-based generative language model. Examples of decoder-based generative language models include versions of models such as GPT, BLOOM, PaLM, Mistral, Gemini, and/or LLaMA. The generative language model 804 can be trained to predict tokens in sequences of textual training data. When employed in inference mode, the output of the generative language model 804 can include new sequences of text that the model generates (e.g., a test program).

Assuming proper guardrails are in place to constrain model outputs, the generative language model 804 is well-suited to produce accurate outputs in contexts where text is strictly defined and structured such as computer program code. To that end, supplementing an input (e.g., a prompt, a query) to the generative language model 804 with natural language documentation 806 that is associated with the static analysis tool 808 provides a well-defined context to inform the generation and/or output of the test program 810. In a specific example, the static analysis tool 808 is a BPF verifier for analyzing BPF bytecode programs. Consequently, the natural language documentation 806 is the BPF instruction set architecture that defines valid BPF bytecode instructions and syntax.

Accordingly, the test program generator 802 outputs a sequence of instructions 814 that conform to the requirements defined by the natural language documentation 806. Similar to the example discussed above, the instructions 814 perform various operations 816 that evaluate various aspects of the static analysis tool 808. Likewise, the test program 810 output by the generative language model 804 includes data 818 for initializing the test program 810 and instrumentation 820 for providing visibility during execution by the concrete implementation 812. In various examples, the data 818 and/or the instrumentation 820 is output by the generative language model 804 in conjunction with the instructions 814. Alternatively, the data 818 and/or the instrumentation 820 is output by a separate tool.

Accordingly, the test program 810 is verified by the static analysis tool 808 and subsequently executed by the concrete implementation 812 to produce a set of test program execution results 822. As discussed above with respect to FIGS. 7A and 7B, the test program execution results 822 can assist a developer in identifying and/or troubleshooting issues as well as provide additional data to the generative language model 804 of the test program generator 802. As such, the test program execution results 822 extend the context of the generative language model 804 to enable successive iterations of the test program 810 to build upon its complexity and provide thorough testing of the static analysis tool 808. Furthermore, the test program execution results 822 can serve as an additional input, along with the natural language documentation 806 and the input instruction 809, to the generative language model 804. Consequently, this suite of inputs enables the generative language model 804 to output gradually more complex iterations of the test program 810 to uncover potential issues within the static analysis tool 808 and/or the concrete implementation 812.

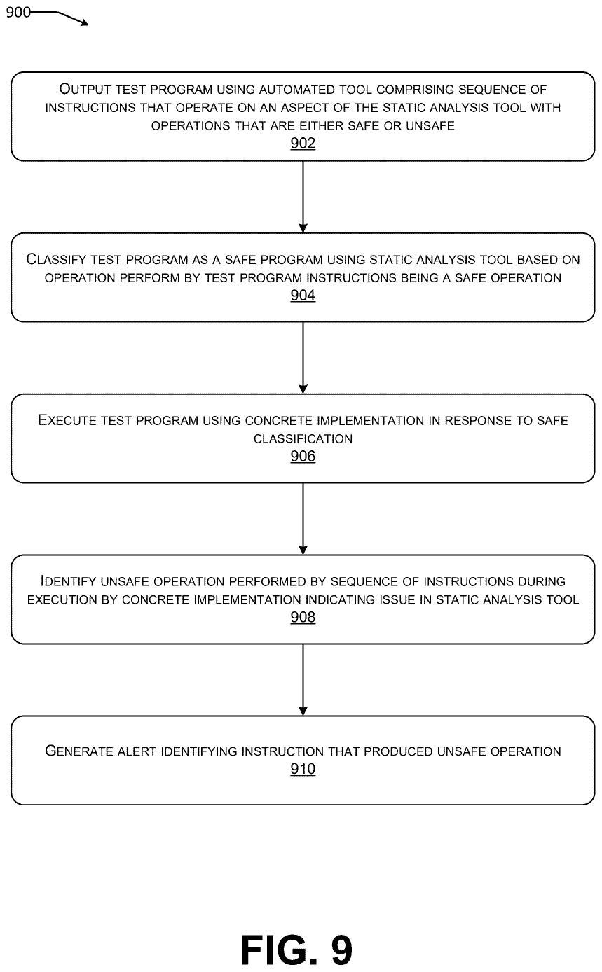

Turning now to FIG. 9, aspects of a process 900 for generating and evaluating a test program for validating a static analysis tool are shown and described. With respect to FIG. 9, the process 900 begins at operation 902 where an automated tool generates a test program comprising a sequence of instructions. As described above, the sequence of instructions perform various operations that evaluate one or more aspects of the static analysis tool. In addition, individual operations can be either a safe operation or an unsafe operation. In one example, the automated tool is a machine learning model implementing an evolutionary algorithm. In another example, the automated tool is a generative language model utilizing natural language documentation.

Next, at operation 904, the static analysis tool classifies the test program as a safe program based on an analysis of the sequence of instructions and the operations it performs being safe operations. In various examples, a program is classified as safe if the safe operations performed by the sequence of instructions does not cause an error, instability, or otherwise compromises the security of the system executing the program.

Then, at operation 906, in response to the static analysis tool classifying the test program as a safe program, the concrete implementation loads and executes the test program. In various examples, the concrete implementation is a “real” machine (e.g., a virtual machine, a native machine). In contrast to the static analysis tool, the concrete implementation executes the test program to provide visibility into the actual behavior of the test program under real-world circumstances.

Subsequently, at operation 908, the validation system identifies an unsafe operation during execution of the test program by the concrete implementation. As such, identifying the unsafe operation despite the static analysis tool classifying the test program as safe indicates that at least one issue (e.g., a bug) in the static analysis tool.

Finally, at operation 910, the validation system generates an alert identifying the instruction that produced the unsafe operation. In this way, the alert can assist a developer to identify the root cause of the issue by pinpointing where in the test program the unsafe operation occurred.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated method can begin and/or end at any time and need not be performed in its entirety. Some or all operations of the method, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the process 900 can be implemented, at least in part, by modules running the features disclosed herein can be a dynamically linked library, a statically linked library, functionality produced by an application programing interface, a compiled program, an interpreted program, a script, or any other executable set of instructions. Data can be stored in a data structure in one or more memory components. Data can be retrieved from the data structure by addressing links or references to the data structure.

Although the illustration may refer to the components of the figures, it should be appreciated that the operations of the process 900 may also be implemented in other ways. In addition, one or more of the operations of the process 900 may alternatively or additionally be implemented, at least in part, by a chipset working alone or in conjunction with other software modules. In the example described below, one or more modules of a computing system can receive and/or process the data disclosed herein. Any service, circuit, or application suitable for providing the techniques disclosed herein can be used in operations described herein.

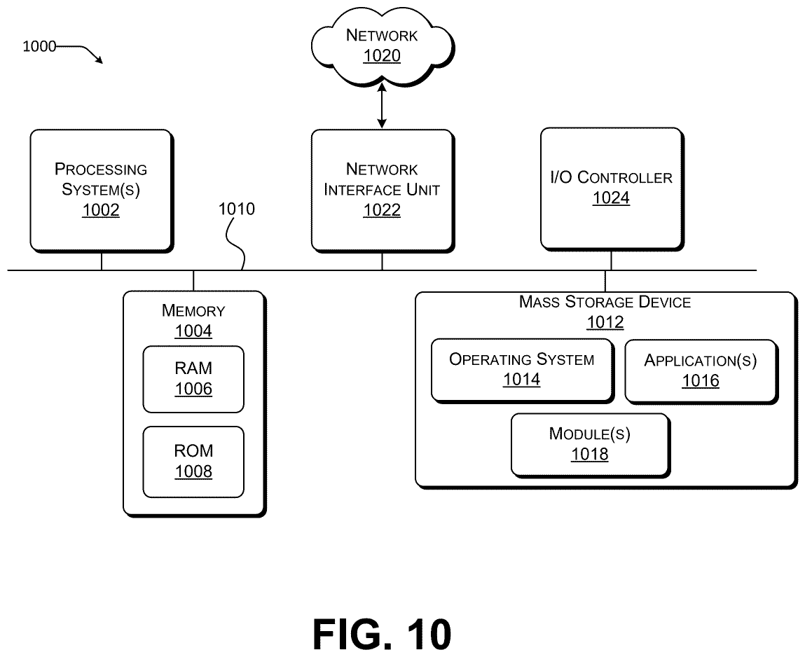

FIG. 10 shows additional details of an example computer architecture 1000 for a device, such as a computer or a server configured as part of the cloud-based platform or system 100, capable of executing computer instructions (e.g., a module or a program component described herein). The computer architecture 1000 illustrated in FIG. 10 includes processing unit(s) 1002, a system memory 1004, including a random-access memory 1006 (RAM) and a read-only memory (ROM) 1008, and a system bus 1010 that couples the memory 1004 to the processing unit(s) 1002.

Processing unit(s), such as processing unit(s) 1002, can represent, for example, a central processing unit (CPU)-type processing unit, a graphical process unit (GPU)-type processing unit, a field-programmable gate array (FPGA), another class of digital signal processor (DSP), or other hardware logic components that may, in some instances, be driven by a CPU. For example, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), etc.

A basic input/output system containing the basic routines that help to transfer information between elements within the computer architecture 1000, such as during startup, is stored in the ROM 1008. The computer architecture 1000 further includes a mass storage device 1012 for storing an operating system 1014, application(s) 1016, modules 1018, and other data described herein.

The mass storage device 1012 is connected to processing unit(s) 1002 through a mass storage controller connected to the bus 1010. The mass storage device 1012 and its associated computer-readable media provide non-volatile storage for the computer architecture 1000. Although the description of computer-readable media contained herein refers to a mass storage device, it should be appreciated by those skilled in the art that computer-readable media can be any available computer-readable storage media or communication media that can be accessed by the computer architecture 1000.

Computer-readable media can include computer-readable storage media and/or communication media. Computer-readable storage media can include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including random access memory (RAM), static random-access memory (SRAM), dynamic random-access memory (DRAM), phase change memory (PCM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 1000 may operate in a networked environment using logical connections to remote computers through the network 1020. The computer architecture 1000 may connect to the network 1020 through a network interface unit 1022 connected to the bus 1010. The computer architecture 1000 also may include an input/output controller 1024 for receiving and processing input from a number of other devices, including a keyboard, mouse, touch, or electronic stylus or pen. Similarly, the input/output controller 1024 may provide output to a display screen, a printer, or other type of output device.

It should be appreciated that the software components described herein may, when loaded into the processing unit(s) 1002 and executed, transform the processing unit(s) 1002 and the overall computer architecture 1000 from a general-purpose computing system into a special-purpose computing system customized to facilitate the functionality presented herein. The processing unit(s) 1002 may be constructed from any number of transistors or other discrete circuit elements, which may individually or collectively assume any number of states. More specifically, the processing unit(s) 1002 may operate as a finite-state machine, in response to executable instructions contained within the software modules disclosed herein. These computer-executable instructions may transform the processing unit(s) 1002 by specifying how the processing unit(s) 1002 transition between states, thereby transforming the transistors or other discrete hardware elements constituting the processing unit(s) 1002.

The disclosure presented herein also encompasses the subject matter set forth in the following clauses.

Example Clause A, a method for generating and evaluating a test program for validating a static analysis tool against a concrete implementation executing the test program, the method comprising: generating, by an automated tool, a test program comprising a sequence of instructions wherein: the test program operates on an aspect of the static analysis tool; and the sequence of instructions performs an operation that is one of a safe operation or an unsafe operation; classifying, by the static analysis tool, the test program as a safe program based on the operation performed by the sequence of instructions being a safe operation; in response to classifying the test program as a safe program, executing the test program using the concrete implementation; identifying an unsafe operation performed by the sequence of instructions during execution by the concrete implementation, wherein identifying the unsafe operation indicates an issue in the aspect of static analysis tool being operated on by the test program; and generating an alert identifying an instruction of the sequence of instructions that produced the unsafe operation.

Example Clause B, the method of Example Clause A, wherein: the test program is a first test program; the sequence of instructions is a first sequence of instructions; the operation is a first operation; the aspect of the static analysis tool is a first aspect; and the method further comprises generating a second test program to further validate the static analysis tool, the second test program comprising a second sequence of instructions, wherein: the second test program operates on a second aspect of the static analysis tool in addition to the first aspect; the second sequence of instructions performs a second operation in addition to the first operation; and the first operation and the second operation are one of a safe operation or an unsafe operation.

Example Clause C, the method of Example Clause A or Example Clause B, wherein: the automated tool includes a machine learning model implementing an evolutionary algorithm; and a fitness function of the evolutionary algorithm quantifies an extent of code coverage of the test program.

Example Clause D, the method of Example Clause A or Example Clause B, wherein: the automated tool includes a generative language model; and the generative language model generates the test program based on a natural language documentation associated with the static analysis tool.

Example Clause E, the method of any one of Example Clause A through D, wherein generating the test program further comprises instrumenting the test program to output a concrete state at each instruction of the sequence of instructions during execution by the concrete implementation.

Example Clause F, the method of any one of Example Clause A through E, wherein the sequence of instructions is a sequence of bytecode instructions.

Example Clause G, the method of any one of Example Clause A through F, wherein the alert includes an instruction of the sequence of instructions preceding the instruction that produced the unsafe operation.

Example Clause H, a system for generating and evaluating a test program for validating a static analysis tool against a concrete implementation executing the test program, the system comprising: a processing system; and a computer-readable medium having encoded thereon, computer-readable instructions that when executed by the processing system, cause the system to perform operations comprising: generating, by an automated tool, a test program comprising a sequence of instructions wherein: the test program operates on an aspect of the static analysis tool; and the sequence of instructions performs an operation that is one of a safe operation or an unsafe operation; classifying, by the static analysis tool, the test program as a safe program based on the operation performed by the sequence of instructions being a safe operation; in response to classifying the test program as a safe program, executing the test program using the concrete implementation; identifying an unsafe operation performed by the sequence of instructions during execution by the concrete implementation, wherein identifying the unsafe operation indicates an issue in the aspect of static analysis tool being operated on by the test program; and generating an alert identifying an instruction of the sequence of instructions that produced the unsafe operation.

Example Clause I, the system of Example Clause H, wherein: the test program is a first test program; the sequence of instructions is a first sequence of instructions; the operation is a first operation; the aspect of the static analysis tool is a first aspect; and the operations further comprises generating a second test program to further validate the static analysis tool, the second test program comprising a second sequence of instructions, wherein: the second test program operates on a second aspect of the static analysis tool in addition to the first aspect; the second sequence of instructions performs a second operation in addition to the first operation; and the first operation and the second operation are one of a safe operation or an unsafe operation.

Example Clause J, the system of Example Clause H or Example Clause I, wherein: the automated tool includes a machine learning model implementing an evolutionary algorithm; and a fitness function of the evolutionary algorithm quantifies an extent of code coverage of the test program.

Example Clause K, the system of Example Clause H or Example Clause I, wherein: the automated tool includes generative language model; and the generative language model generates the test program based on a natural language documentation associated with the static analysis tool.

Example Clause L, the system of any one of Example Clause H through K, wherein generating the test program further comprises instrumenting the test program to output a concrete state at each instruction of the sequence of instructions during execution by the concrete implementation.

Example Clause M, the system of any one of Example Clause H through L, wherein: the test program is a BPF program; and the sequence of instructions is a sequence of bytecode instructions.

Example Clause N, the system of any one of Example Clause H through M, wherein the alert includes an instruction of the sequence of instructions that precedes the instruction that produced the unsafe operation.

Example Clause O, a computer-readable medium for generating and evaluating a test program for validating a static analysis tool against a concrete implementation executing the test program, the computer-readable medium having encoded thereon, computer-readable instructions that, when executed by a system, cause the system to perform operations comprising: generating, by an automated tool, a test program comprising a sequence of instructions wherein: the test program operates on an aspect of the static analysis tool; and the sequence of instructions performs an operation that is one of a safe operation or an unsafe operation; classifying, by the static analysis tool, the test program as a safe program based on the operation performed by the sequence of instructions being a safe operation; in response to classifying the test program as a safe program, executing the test program using the concrete implementation; identifying an unsafe operation performed by the sequence of instructions during execution by the concrete implementation, wherein identifying the unsafe operation indicates an issue in the aspect of static analysis tool being operated on by the test program; and generating an alert identifying an instruction of the sequence of instructions that produced the unsafe operation.

Example Clause P, the computer-readable medium of Example Clause O, wherein: the test program is a first test program; the sequence of instructions is a first sequence of instructions; the operation is a first operation; the aspect of the static analysis tool is a first aspect; and the method further comprises generating a second test program to further validate the static analysis tool, the second test program comprising a second sequence of instructions, wherein: the second test program operates on a second aspect of the static analysis tool in addition to the first aspect; the second sequence of instructions performs a second operation in addition to the first operation; and the first operation and the second operation are one of a safe operation or an unsafe operation.

Example Clause Q, the computer-readable medium of Example Clause O or Example Clause P, wherein: the automated tool includes a machine learning model implementing an evolutionary algorithm; and a fitness function of the evolutionary algorithm quantifies an extent of code coverage of the test program.

Example Clause R, the computer-readable medium of Example Clause O or Example Clause P, wherein: the automated tool includes generative language model; and the generative language model generates the test program based on a natural language documentation associated with the static analysis tool.

Example Clause S, the computer-readable medium of any one of Example Clause O through Example Clause R, wherein generating the test program further comprises instrumenting the test program to output a concrete state at each instruction of the sequence of instructions during execution by the concrete implementation.

Example Clause T, the computer-readable medium of any one of Example Clause O through Example Clause S, wherein the alert includes an instruction of the sequence of instructions preceding the instruction that produced the unsafe operation.

Conditional language such as, among others, “can,” “could,” “might” or “may,” unless specifically stated otherwise, are understood within the context to present that certain examples include, while other examples do not include, certain features, elements, and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

The terms “a,” “an,” “the” and similar referents used in the context of describing the invention (especially in the context of the following claims) are to be construed to cover both the singular and the plural unless otherwise indicated herein or clearly contradicted by context. The terms “based on,” “based upon,” and similar referents are to be construed as meaning “based at least in part” which includes being “based in part” and “based in whole” unless otherwise indicated or clearly contradicted by context.

In addition, any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method for generating and evaluating a test program for validating a static analysis tool against a concrete implementation executing the test program, the method comprising:
generating, by an automated tool, a test program comprising a sequence of instructions wherein:
the test program operates on an aspect of the static analysis tool; and
the sequence of instructions performs an operation that is one of a safe operation or an unsafe operation;
classifying, by the static analysis tool, the test program as a safe program based on the operation performed by the sequence of instructions being a safe operation;
in response to classifying the test program as a safe program, executing the test program using the concrete implementation;
identifying an unsafe operation performed by the sequence of instructions during execution by the concrete implementation, wherein identifying the unsafe operation indicates an issue in the aspect of static analysis tool being operated on by the test program; and
generating an alert identifying an instruction of the sequence of instructions that produced the unsafe operation.

2. The method of claim 1, wherein:
the test program is a first test program;
the sequence of instructions is a first sequence of instructions;
the operation is a first operation;
the aspect of the static analysis tool is a first aspect; and
the method further comprises generating a second test program to further validate the static analysis tool, the second test program comprising a second sequence of instructions, wherein:
the second test program operates on a second aspect of the static analysis tool in addition to the first aspect;
the second sequence of instructions performs a second operation in addition to the first operation; and
the first operation and the second operation are one of a safe operation or an unsafe operation.

3. The method of claim 1, wherein:
the automated tool includes a machine learning model implementing an evolutionary algorithm; and
a fitness function of the evolutionary algorithm quantifies an extent of code coverage of the test program.

4. The method of claim 1, wherein:
the automated tool includes a generative language model; and
the generative language model generates the test program based on a natural language documentation associated with the static analysis tool.

5. The method of claim 1, wherein generating the test program further comprises instrumenting the test program to output a concrete state at each instruction of the sequence of instructions during execution by the concrete implementation.

6. The method of claim 1, wherein the sequence of instructions is a sequence of bytecode instructions.

7. The method of claim 1, wherein the alert includes an instruction of the sequence of instructions preceding the instruction that produced the unsafe operation.

8. A system for generating and evaluating a test program for validating a static analysis tool against a concrete implementation executing the test program, the system comprising:
a processing system; and
a computer-readable medium having encoded thereon, computer-readable instructions that when executed by the processing system, cause the system to perform operations comprising:
generating, by an automated tool, a test program comprising a sequence of instructions wherein:
the test program operates on an aspect of the static analysis tool; and
the sequence of instructions performs an operation that is one of a safe operation or an unsafe operation;
classifying, by the static analysis tool, the test program as a safe program based on the operation performed by the sequence of instructions being a safe operation;
in response to classifying the test program as a safe program, executing the test program using the concrete implementation;
identifying an unsafe operation performed by the sequence of instructions during execution by the concrete implementation, wherein identifying the unsafe operation indicates an issue in the aspect of static analysis tool being operated on by the test program; and
generating an alert identifying an instruction of the sequence of instructions that produced the unsafe operation.

9. The system of claim 8, wherein:
the test program is a first test program;
the sequence of instructions is a first sequence of instructions;
the operation is a first operation;
the aspect of the static analysis tool is a first aspect; and
the operations further comprise generating a second test program to further validate the static analysis tool, the second test program comprising a second sequence of instructions, wherein:
the second test program operates on a second aspect of the static analysis tool in addition to the first aspect;
the second sequence of instructions performs a second operation in addition to the first operation; and
the first operation and the second operation are one of a safe operation or an unsafe operation.

10. The system of claim 8, wherein:
the automated tool includes a machine learning model implementing an evolutionary algorithm; and
a fitness function of the evolutionary algorithm quantifies an extent of code coverage of the test program.

11. The system of claim 8, wherein:
the automated tool includes generative language model; and
the generative language model generates the test program based on a natural language documentation associated with the static analysis tool.

12. The system of claim 8, wherein generating the test program further comprises instrumenting the test program to output a concrete state at each instruction of the sequence of instructions during execution by the concrete implementation.

13. The system of claim 8, wherein:
the test program is a BPF program; and
the sequence of instructions is a sequence of bytecode instructions.

14. The system of claim 8, wherein the alert includes an instruction of the sequence of instructions that precedes the instruction that produced the unsafe operation.

15. A computer-readable medium for generating and evaluating a test program for validating a static analysis tool against a concrete implementation executing the test program, the computer-readable medium having encoded thereon, computer-readable instructions that, when executed by a system, cause the system to perform operations comprising:
generating, by an automated tool, a test program comprising a sequence of instructions wherein:
the test program operates on an aspect of the static analysis tool; and
the sequence of instructions performs an operation that is one of a safe operation or an unsafe operation;
classifying, by the static analysis tool, the test program as a safe program based on the operation performed by the sequence of instructions being a safe operation;
in response to classifying the test program as a safe program, executing the test program using the concrete implementation;
identifying an unsafe operation performed by the sequence of instructions during execution by the concrete implementation, wherein identifying the unsafe operation indicates an issue in the aspect of static analysis tool being operated on by the test program; and
generating an alert identifying an instruction of the sequence of instructions that produced the unsafe operation.

16. The computer-readable medium of claim 15, wherein:
the test program is a first test program;
the sequence of instructions is a first sequence of instructions;
the operation is a first operation;
the aspect of the static analysis tool is a first aspect; and
the method further comprises generating a second test program to further validate the static analysis tool, the second test program comprising a second sequence of instructions, wherein:
the second test program operates on a second aspect of the static analysis tool in addition to the first aspect;
the second sequence of instructions performs a second operation in addition to the first operation; and
the first operation and the second operation are one of a safe operation or an unsafe operation.

17. The computer-readable medium of claim 15, wherein:
the automated tool includes a machine learning model implementing an evolutionary algorithm; and
a fitness function of the evolutionary algorithm quantifies an extent of code coverage of the test program.

18. The computer-readable medium of claim 15, wherein:
the automated tool includes generative language model; and
the generative language model generates the test program based on a natural language documentation associated with the static analysis tool.

19. The computer-readable medium of claim 15, wherein generating the test program further comprises instrumenting the test program to output a concrete state at each instruction of the sequence of instructions during execution by the concrete implementation.

20. The computer-readable medium of claim 15, wherein the alert includes an instruction of the sequence of instructions preceding the instruction that produced the unsafe operation.
